(19) United States
(12) Patent Application Publication
(10) Pub. No.: US 2008/0262737 A1
(43) Pub. Date: Oct. 23, 2008

(54) System and Method for Monitoring and Controlling Production from Wells

(75) Inventors: Brian L. Thigpen, Houston, TX (US); Guy P. Vachon, Houston, TX (US); Garabed Yeriazarian, Katy, TX (US); Jaedong Lee, Katy, TX (US); Chee M. Chok, Houston, TX (US); Clark Sann, Houston, TX (US); Xin Liu, Katy, TX (US)

Correspondence Address: MADAN, MOSSMAN & SRIRAM, P.C., 2603 AUGUSTA DRIVE, SUITE 700, HOUSTON, TX, 77057-5662, US

(73) Assignee: BAKER HUGHES INCORPORATED, Houston, TX (US)

(21) Appl. No.: 11/737,402

(22) Filed: Apr. 19, 2007

(51) Int. Cl. G01V 1/40

(52) U.S. Cl. 702/9; 166/369

(57) ABSTRACT

A system and method for obtaining enhanced production from a well is provided. The system includes a processor that processes instructions contained in a computer program, which includes instructions to monitor actual flow rate of the fluid from each production zone of a well over a time period corresponding to a first setting of the flow control devices and to employ a nodal analysis on a plurality of inputs from downhole sensor measurements, surface sensor measurements, one or more current positions of the devices to determine one or more new settings that will provide enhanced production from the well.

### BACKGROUND OF THE DISCLOSURE

1. Field of the Disclosure

This disclosure relates generally to monitoring of well operations and production of hydrocarbons from such wells.

2. Background of the Art

Wellbores are drilled in subsurface formations for the production of hydrocarbons (oil and gas). Some such wells are vertical or near vertical wells that penetrate more than one reservoir or production zones. Inclined and horizontals wells also have become common, wherein the well traverses the production zone substantially horizontally, i.e., substantially along the length of the reservoir. In some cases, branch wells are drilled from a main well into different reservoirs. Often several spaced apart wells are drilled into these reservoirs or oil fields. To optimize the hydrocarbon production, the reservoir is initially characterized or modeled, generally an initial approximation of the actual reservoir and its behavior. A development plan is typically made based on this initial model and the wells are put into production. As the reservoir is depleted, its conditions change and knowledge gathered during this production phase is used to modify the reservoir model to optimize the overall production from the reservoir. Such an optimization loop is typically designed to optimize the overall production from the field and is designed to improve the understanding of the actual structure of the reservoir. This process typically continues over the life of the field until the end of the life of the reservoir. It often takes a very long time to incorporate the ongoing learning about the reservoir into the reservoir model, to propagate it to a modified development plan and to mobilize resources to drill and complete new wells. This is an iterative process wherein each iteration of the model can often take several months to several years.

Another optimization loop pertains to increasing or maximizing the performance of the individual wells. In such a loop, the performance of the well is monitored and compared with the expected performance of the well. Steps are taken to restore the production to the expected level. Such a loop has traditionally been closed through well intervention or through control actions taken at the surface.

Relatively complex wells typically include a casing that lines the wellbore. Certain permanent sensors are installed in the well to monitor certain parameters of the well and the formations surrounding the well. Remotely controlled valves and chokes are placed in the well to control the fluid flow from one or more production zones. Chemicals or additives are often injected from a surface supply source into the well to inhibit the formation of scale, corrosion, hydrates, asphaltenes, etc. in the well. An artificial lift mechanism, such as an electrical submersible pump (ESP) or a gas injection system is sometimes deployed in the well to lift the fluid produced from the formations to the surface.

An operator usually reviews the data from the various downhole and surface sensors and devices, and interprets such data to estimate or interpret the state of the well. The operator sends commands to the control systems that control the downhole and surface devices to effect the desired changes in the production of the fluids through the well. Such actions may include altering the operation of the ESP, closing or opening of valves and chokes, altering injection of the chemicals, etc. Such a loop, to a great extent, involves human interpretation and intervention, which may be prone to errors or may take relatively excessive time, which in some instances may result in incorrect actions and/or delay the taking of one or more actions. Such interpretation and actions also may not appropriately enhance or maximize production from the well over a selected time period, which may be the lifetime of the well.

Therefore, there is a need for an improved system and method for monitoring the condition of the well and taking action that may enhance or maximize the production from the well controlling the production of fluid from such well.

### SUMMARY OF THE DISCLOSURE

A method of producing fluid from a completed well is disclosed that includes: (i) estimating an expected fluid flow rate from at least one production zone into the well as a function of time corresponding to a first setting of at least one flow device in the well that enables the fluid from the well to enter the well; (ii) monitoring the actual flow rate of the fluid from the at least one production zone into the well over a time period corresponding to the first setting of the at least one flow device; (iii) determining using a computer model and a plurality of inputs from downhole sensor measurements, surface sensor measurements and a parameter of the at least one downhole device at least one second setting of the at least one flow device from a declining trend of the actual flow rate, which second setting will increase the flow rate of the fluid from the at least one production zone to above the expected fluid flow from the at least one production zone; (iv) and operating the well corresponding to the at least one second setting to obtain enhanced production of the fluid from the at least one production zone. The method may estimate a second fluid flow rate over an extended time period from the at least one production zone based on the at least one second setting. The method may then compute a net present value (NPV) for the well based on the at least one second setting.

The inputs may be selected from information relating to pressure in the well, flow rates in the well, flow rates at the surface, operating parameters of an electrical submersible pump, chemical injection rates, temperature, resistivity of the formation or fluid, density of the fluid, fluid composition, capacitance measurements relating to the fluid; vibrations in the well, acoustic measurements in the well, differential pressure across a device in the well, water content, oil-water ratio, gas-oil ratio, and oil-water ratio. Other data and measurements may also be used, including, but not limited to, microseismic measurements, pressure transient test measurements, well log measurements, measurements relating to the presence of one or more chemicals in the well that may include scale, hydrate, corrosion and asphaltene. In another aspect, the method may estimate an occurrence one or more of a water breakthrough, cross-flow condition, deterioration of a casing in the well or deterioration of a device in the well and then determine the second setting or settings based on such estimation. Other settings may be made include changes in the chemical injection rate, operation of an ESP, shutting in a selected production zone, etc. In another aspect, messages may be sent to an operator at the well and/or a remote location about the second setting. The actual production may be continually monitored after setting the devices to their new settings. The process is then repeated. The method also provides for updating the expected fluid flow rate from the well or a production zone based on the at least one second setting.

In another aspect, messages may be sent to an operator at the well and/or a remote location about the second setting. The actual production may be continually monitored after setting the devices to their new settings. The process is then repeated. The method also provides for updating the expected fluid flow rate from the well or a production zone based on the at least one second setting.

In another aspect, a system for obtaining enhanced production from a well that includes a plurality of production zones, a separate flow control device associated with each production zone and an artificial lift device, is provided that includes: a computer system that has a processor, a computer readable medium for storing computer programs and data that is accessible to the computer for executing instructions contained in the computer program and a display device for displaying information sent by the processor, wherein the computer program includes: (i) a set of instructions to monitor actual flow rate of the fluid from each production zone over a time period corresponding to a first setting of each flow control device and the flow through the artificial device; (ii) a set of instructions to employ a nodal analysis on a plurality of inputs from downhole sensor measurements, surface sensor measurements, current position of at least one flow control device to determine a new setting for at least one flow control device from a declining trend of the actual flow rate to obtain enhanced production from the well; and (iii) a set of instructions to continue to monitor the enhanced flow rate corresponding to the new setting.

Examples of the more important features of a system for monitoring and controlling production from wells have been summarized rather broadly in order that the detailed description thereof that follows may be better understood, and in order that the contributions to the art may be appreciated. There are, of course, additional features that will be described hereinafter and which will form the subject of the claims.

### BRIEF DESCRIPTION OF THE DRAWINGS

For a detailed understanding of the system and methods for monitoring and controlling production wells described and claimed herein, reference should be made to the accompanying drawings and the following detailed description of the drawings wherein like elements generally have been given like numerals, and wherein:

FIG. 1 is a high level flow diagram of a closed-loop well monitoring and control system according to one aspect of the disclosure;

FIGS. 2A and 2B collectively show a schematic diagram of a production well system for producing fluid from multiple production zones according to one possible embodiment;

FIG. 3 is an exemplary functional diagram of a control system that may be utilized for a well system, including the system shown in FIGS. 1A and 1B, to take various measurements relating to the well, determine desired actions that may be taken to improve production from the well, automatically take of one or more such actions, predict the effects of such actions and monitor the well performance after taking of such actions;

FIG. 4 is an exemplary pressure transient curve over time for a producing well, such as well shown in FIGS. 1A and 1B that in one aspect may be used to control the production from the well; and

FIG. 5 is an exemplary graph that shows an expected performance of a well, such a well of FIG. 1A and actual performance of such well and examples of pertinent times when the systems described herein may take one or more desired action and the behavior of the well subsequent to the taking of such actions.

FIG. 6 is a functional diagram showing a well performance analyzer software that may be utilized to analyze data and provide an action plan to enhance production for loop 1A shown in FIG. 1.

### DETAILED DESCRIPTION OF THE DRAWINGS

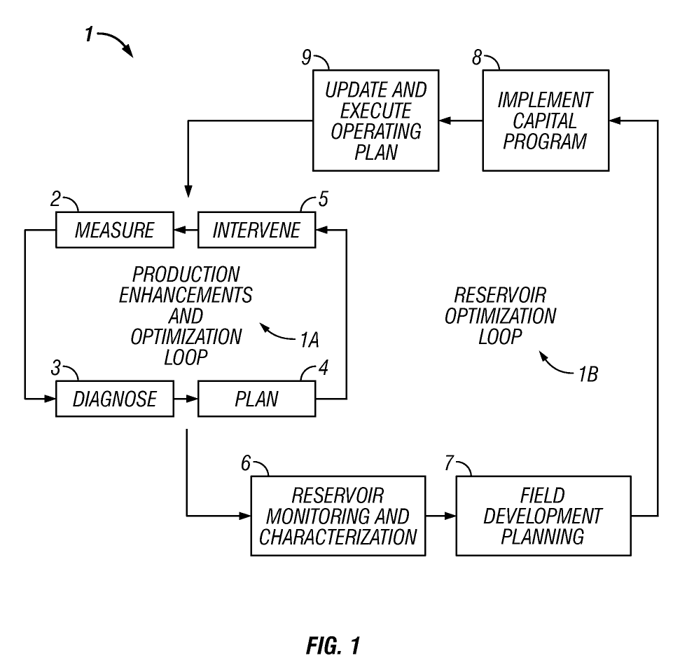

FIG. 1 shows a high level flow diagram of a production system 1 that includes a production enhancement and optimization loop or system 1A for a particular well and the integration of such a loop into a reservoir or field optimization system or loop 1B. Before developing the field for oil and gas production, a model or loop 1B for the field is developed. The execution and updating of loop 1B is a relatively long term process and tends to optimize the production from the field. Loop 1B may include field development plan 7 relating to the location, depth and type of wells to be drilled. The plan is usually based on reservoir characterization 6 that may utilize data from a variety of sources, including seismic data (two-dimensional or three-dimensional maps), data from other fields in the region; rock analysis of the potentially producing formations, etc. Using an economic analysis, a capital program 8 is developed for the drilling and completion of the wells in a field. The plan is executed 9 and updated based on the well performance information of the wells.

Loop 1A, in one aspect, is a closed loop that may be configured to enhance or maximize the production from a particular well in the field. In loop 1B, the well system continuously monitors or measures various parameters 2 of a well that includes downhole and surface parameters; continuously diagnoses or analyzes 3 a variety of data, including prior well data and the ongoing measurements from the variety of downhole and surface sensors, using programs, models and algorithms developed for the system 1B; and provides an action plan 4 when the results of the analysis indicate that the production from the well is outside a selected or desired range. The action plan 4 may include suggested actions to an operator for altering one or more of the parameters of the well, such as altering flow from one or more zones, altering chemical injection or altering the operation of an ESP, etc.

The system or loop 1A, in one aspect, continues to monitor the well after the operator has taken one or more actions and estimates the impact of the actions taken on the well production and other parameters and continues to analyze and send messages to the operator as needed. In another aspect, the system 1B may be configured to automatically intervene 5 and take or cause to take one or more actions. This may be triggered when the operator fails to take an action or takes an inadequate action or when the conditions of the well warrant certain actions, which action may include any of the actions suggested to the operator and other actions that may be appropriate under emergency situations, such as water breakthrough, cross flow, etc. System 1A may be configured to take any action, including shutting production from any zone or the well or shutting the electrical submersible pump, injection of chemicals etc. The operation of the system or loop 1 for a single exemplary well is described in more detail in reference FIGS. 1A, 1B and 2-5.

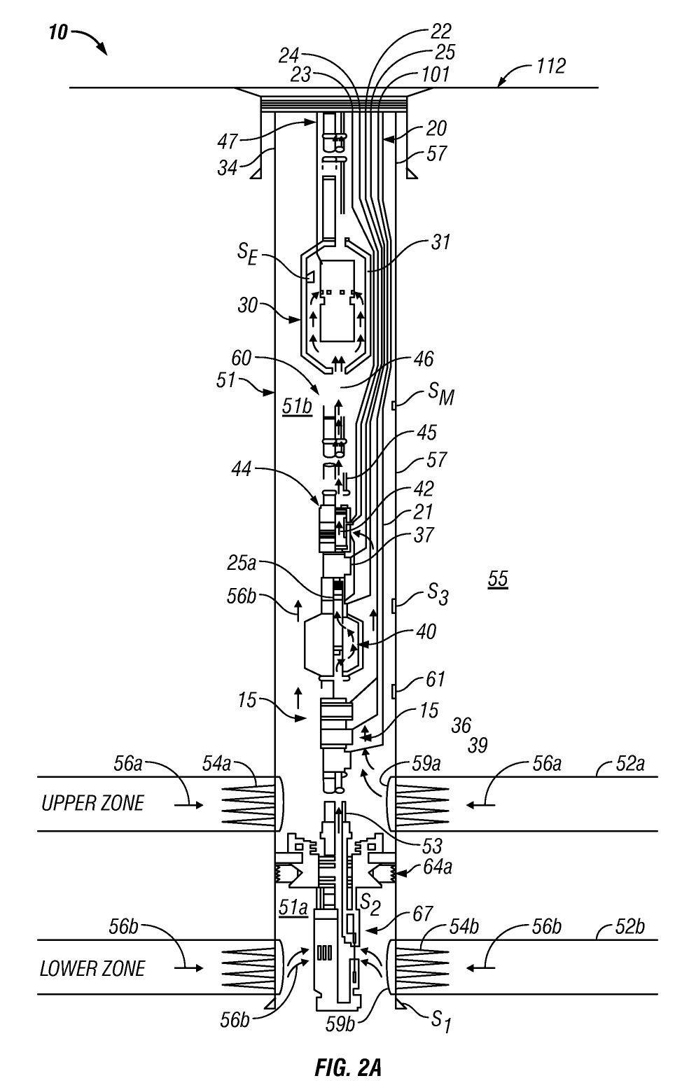

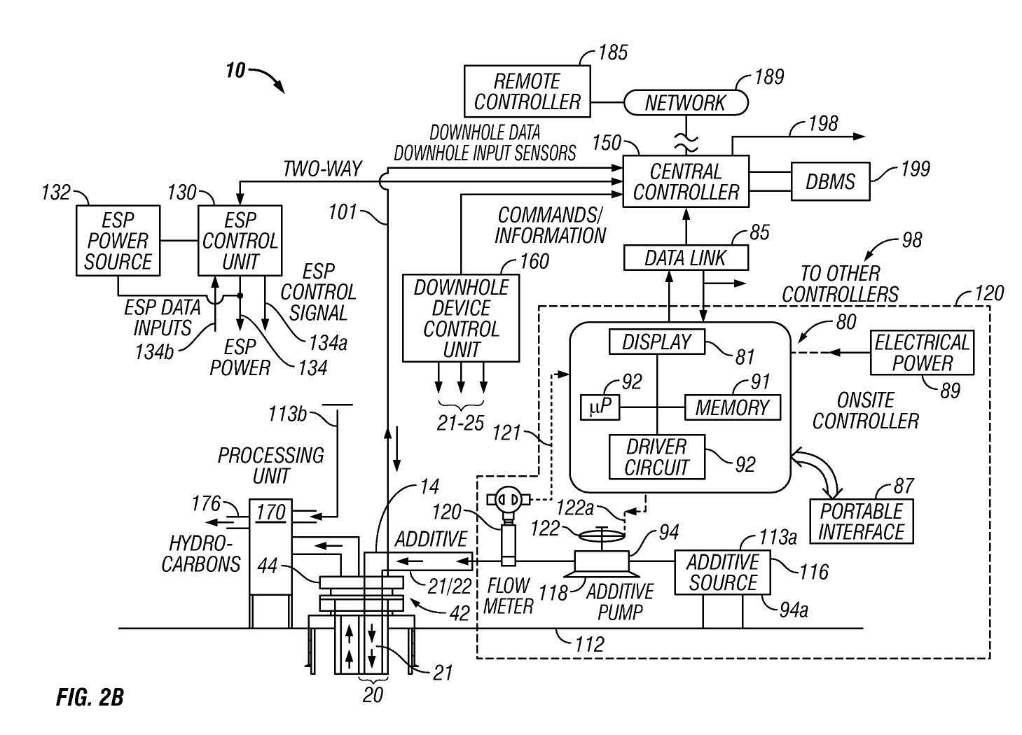

FIGS. 2A and 2B collectively show a schematic diagram of a production well system 10 according to one embodiment of the disclosure. FIG. 2A shows a production well 50 that is configured using exemplary equipment, devices and sensors that may be utilized to implement the concepts and methods described herein. FIG. 2B shows exemplary surface equipment, devices, sensors, controllers, computer programs, models and algorithms that may be utilized to monitor and maintain, enhance, optimize or maximize production from the well 50. In one aspect, the system 10 is configured to periodically or continuously utilize measurements from various sensors and other data to determine the performance of the well, including flow from each production zone, conditions of the various devices in the system 10, predict the behavior and condition of the well 50 and its related equipment, including sand production, water production, water breakthrough, cross-flow condition, water front location, and the health of the various devices, etc. In another aspect, the system 10 may be configured to determine the desired actions that may be taken to enhance or maximize production from the well 50 according to the selected criteria. In another aspect, system 10 may be configured to send desired messages and alarms to an operator and/or to other locations relating to the condition of the well and the adjustments to be made or actions to be taken relating to the various operations of the well 50 to do one or more of: control, enhance, optimize or maximize the production from the well; mitigate or eliminate negative effects of the potential or actual occurrence of a detrimental condition, such as build up of certain chemicals, such as scale, corrosion, hydrates and asphaltenes, a potential or actual water breakthrough, cross flow, or deterioration of certain equipment, etc.

In another aspect, system 10 may be configured to monitor actions taken (if any) by the operator in response to the messages sent by the system; update any actions to be taken after any adjustments have been made by the operator; make selected adjustments when the operator fails to take certain actions; automatically control and monitor any one or more of the devices or equipment in the system 10; and provide status reports to the operator and other locations, including one or more remote locations. In another aspect, the system 10 may be configured to establish a two-way communication with one or more remote locations and/or controllers via one or more suitable data communication links, including the Internet, wired or wireless links and using one or more suitable protocols, including the Internet protocols.

FIG. 2A shows a well 50 formed in a formation 55 that produces formation fluids 56a and 56b from two exemplary production zones 52a (upper production zone) and 52b (lower production zone) respectively. The well 50 is shown lined with a casing 57 that has perforations 54a adjacent the upper production zone 52a and perforations 54b adjacent the lower production zone 52b. A packer 64, which may be a retrievable packer, positioned above or uphole of the lower production zone perforations 54a isolate the lower production zone 52b from the upper production zone 52a. A screen 59b adjacent the perforations 54b may be installed to prevent or inhibit solids, such as sand, from entering into the wellbore from the lower production zone 54b. Similarly, a screen 59a may be used adjacent the upper production zone perforations 59a to prevent or inhibit solids from entering into the well 50 from the upper production zone 52a.

The formation fluid 56b from the lower production zone 52b enters the annulus 51a of the well 50 through the perforations 54a and into a tubing 53 via a flow control valve 67. The flow control valve 67 may be a remotely controlled sliding sleeve valve or any other suitable valve or choke that can regulate the flow of the fluid from the annulus 51a into the production tubing 53. An adjustable choke 40 in the tubing 53 may be used to regulate the fluid flow from the lower production zone 52b to the surface 112. The formation fluid 56a from the upper production zone 52a enters the annulus 51b (the annulus portion above the packer 64a) via perforations 54a. The formation fluid 56a enters production tubing or line 45 via inlets 42. An adjustable valve or choke 44 associated with the line 45 regulates the fluid flow into the line 45 and may be used to adjust flow of the fluid to the surface 112. Each valve, choke and other such device in the well may be operated electrically, hydraulically, mechanically and/or pneumatically from the surface. The fluid from the upper production zone 52a and the lower production zone 52b enter the line 46.

In cases where the formation pressure is not sufficient to push the fluid 56a and/or fluid 56b to the surface, an artificial lift mechanism, such as an electrical submersible pump (ESP) or a gas lift system may be utilized to lift the fluids from the well to the surface 112. In the system 10, an ESP 30 in a manifold 31 is shown as the artificial lift mechanism, which receives the formation fluids 56a and 56b and pumps such fluids via tubing 47 to the surface 112. A cable 34 provides power to the ESP 30 from a surface power source 132 (FIG. 2B) that is controlled by an ESP control unit 130. The cable 134 also may include two-way data communication links 134a and 134b, which may include one or more electrical conductors or fiber optic links to provide a two-way signals and data link between the ESP 30, ESP sensors S_{E} and the ESP control unit 130. The ESP control unit 130, in one aspect, controls the operation of the ESP 30. The ESP control unit 130 may be a computer-based system that may include a processor, such as a microprocessor, memory and programs useful for analyzing and controlling the operations of the ESP 30. In one aspect, the controller 130 receives signals from sensors S_{E} (FIG. 2A) relating to the actual pump frequency, flow rate through the ESP, fluid pressure and temperature associated with the ESP 30 measurements or information relating to certain chemicals, such as corrosion, scale, asphaltenes, etc. and in response thereto or other determinations controls the operation of the ESP 30. In one aspect, the ESP control unit 130 may be configured to alter the ESP pump speed by sending control signals 134a in response to the data received via link 134b or instructions received from another controller. The ESP control unit 130 may also shut down power to the ESP via the power line 134. In another aspect, ESP control unit 130 may provide the ESP related data and information (frequency, temperature, pressure, chemical sensor information, etc.) to the central controller 150, which in turn may provide control or command signals to the ESP control unit 130 to effect selected operations of the ESP 30.

A variety of hydraulic, electrical and data communication lines (collectively designated by numeral 20 (FIG. 2A) are run inside the well 50 to operate the various devices in the well 50 and to obtain measurements and other data from the various sensors in the well 50. As an example, a tubing 21 may supply or inject a particular chemical from the surface into the fluid 56b via a mandrel 36. Similarly, a tubing 22 may supply or inject a particular chemical to the fluid 56a in the production tubing via a mandrel 37. Lines 23 and 24 may operate the chokes 40 and 42 and may be used to operate any other device, such as the valve 67. Line 25 may provide electrical power to certain devices downhole from a suitable surface power source. Two-way data communication links between sensors and/or their associated electronic circuits (generally denoted by numeral 25a and located at any one or more suitable downhole locations) may be established by any desired method including but not limited to via wires, optical fibers, acoustic telemetry using a fluid line; electromagnetic telemetry etc.

In one aspect, a variety of other sensors are placed at suitable locations in the well 50 to provide measurements or information relating to a number of downhole parameters of interest. In one aspect, one or more gauge or sensor carriers, such as a carrier 15, may be placed in the production tubing to house any number of suitable sensors. The carrier 15 may include one or more temperature sensors, pressure sensors, flow measurement sensors, resistivity sensors, sensors that may provide information about density, viscosity, water content or water cut, etc., and chemical sensors that provide information about scale, corrosion, asphaltenes, hydrates etc. Density sensors provide fluid density measurements for fluid from each production zone and that of the combined fluid from two or more production zones. The resistivity sensor or another suitable sensor may provide measurements relating to the water content or the water cut of the fluid mixture received from each production zones. Other sensors may be used to estimate the oil/water ratio and gas/oil ratio for each production zone and for the combined fluid. The temperature, pressure and flow sensors provide measurements for the pressure, temperature and flow rate of the fluid in the line 53. Additional gauge carriers may be used to obtain pressure, temperature and flow measurements, water content relating to the formation fluid received from the upper production zone 52a. Additional downhole sensors may be used at other desired locations to provide measurements relating to chemical characteristics of the downhole fluid, such as paraffins, hydrates, sulfides, scale, asphaltene, emulsion, etc. Additionally, sensors S₁-Sₘ may be permanently installed in the wellbore 50 to provide acoustic or seismic or microseismic measurements, formation pressure and temperature measurements, resistivity measurements and measurements relating to the properties of the casing 51 and formation 55. Such sensors may be installed in the casing 57 or between the casing 57 and the formation 55. Additionally, the screen 59a and/or screen 59b may be coated with tracers that are released due to the presence of water, which tracers may be detected at the surface or downhole to determine or predict the occurrence of water breakthrough. Sensors also may be provided at the surface, such as a sensor for measuring the water content in the received fluid, total flow rate for the received fluid, fluid pressure at the wellhead, temperature, etc. Other devices may be used to estimate the production of sand for each zone.

In general, sufficient sensors may be suitably placed in the well 50 to obtain measurements relating to each desired parameter of interest. Such sensors may include, but are not limited to: sensors for measuring pressures corresponding to each production zone, pressure along the wellbore, pressure inside the tubings carrying the formation fluid, pressure in the annulus; sensors for measuring temperatures at selected places along the wellbore; sensors for measuring fluid flow rates corresponding to each of the production zones, total flow rate, flow through the ESP; sensors for measuring ESP temperature and pressure; chemical sensors for providing signals corresponding to build up of chemical, such as hydrates, corrosion, scale and asphaltene; acoustic or seismic sensors that measure signals generated at the surface or in offset wells and signals due to the fluid travel from injection wells or due to a fracturing operation; optical sensors for measuring chemical compositions and other parameters; sensors for measuring various characteristics of the formations surrounding the well, such as resistivity, porosity, permeability, fluid density etc. The sensors may be installed in the tubings in the well or in any device or may be permanently installed in the well, for example, in the wellbore casing, in the wellbore wall or between the casing and the wall. The sensors may be of any suitable type, including electrical sensors, mechanical sensors, piezoelectric sensors, fiber optic sensors, optical sensors, etc. The signals from the downhole sensors may be partially or fully processed downhole (such as by a microprocessor and associated electronic circuitry that is in signal or data communication with the downhole sensors and devices) and then communicated to the surface controller 150 via a signal/data link, such as link 101. The signals from downhole sensors may also be sent directly to the controller 150.

Referring back to FIG. 2B, the system 10 is further shown to include a chemical injection unit 120 at the surface for supplying additives 113a into the well 50 and additives 113b to the surface fluid treatment unit 170. The desired additives 113a from a source 116a (such as a storage tank) thereof may be injected into the wellbore 50 via injection lines 21 and 22 by a suitable pump 118, such as a positive displacement pump. The additives 113a flow through the lines 21 and 22 and discharge into the manifolds 30 and 37. The same or different injection lines may be used to supply additives to different production zones. Separate injection lines, such as lines 21 and 22, allow independent injection of different additives at different well depths. In such a case, different additive sources and pumps are employed to store and to pump the desired additives. Additives may also be injected into a surface pipeline, such as line 176 or the surface treatment and processing facility such as unit 170.

A suitable flow meter 120, which may be a high-precision, low-flow, flow meter (such as gear-type meter or a nutating meter), measures the flow rate through lines 21 and 22, and provides signals representative of the corresponding flow rates. The pump 118 is operated by a suitable device 122, such as a motor or a compressed air device. The pump stroke and/or the pump speed may be controlled by the controller 80 via a driver circuit 92 and control line 122a. The controller 80 may control the pump 118 by utilizing programs stored in a memory 91 associated with the controller 80 and/or instructions provided to the controller 80 from the central controller or processor 150 or a remote controller 185. The central controller 150 communicates with the controller 80 via a suitable two-way link 85 that may be a wire, optical fiber or wireless connection that uses any one or more suitable protocols. The controller 80 may include a processor 92, and resident memory 91, for storing programs, tables, data and models. The processor 92, utilizing signals from the flow measuring device received via line 121 and programs stored in the memory 91, determines the flow rate of each of the additives and displays such flow rates on the display 81. A sensor 94 may provide information about one or more parameters of the pump, such the pump speed, stroke length, etc. The pump speed or stroke, is increased when the measured amount of the additive injected is less than the desired amount and decreased when the injected amount is greater than the desired amount. The controller 80 also includes circuits and programs, generally designated by numeral 92 to provide interface with the onsite display 81 and to perform other desired functions. A level sensor 94a provides information about the remaining contents of the source 116. Alternatively, central controller 150 may send commands to controller 80 relating to the additive injection or may perform the functions of the controller 80. While FIGS. 2A-2B illustrate one production well, it should be understood that an oil field can include a plurality of production wells and also a variety of wells, such as offset wells, injection wells, test wells, etc. The tools and devices shown in the figures may be utilized in any number of such wells and can be configured to work cooperatively or independently.

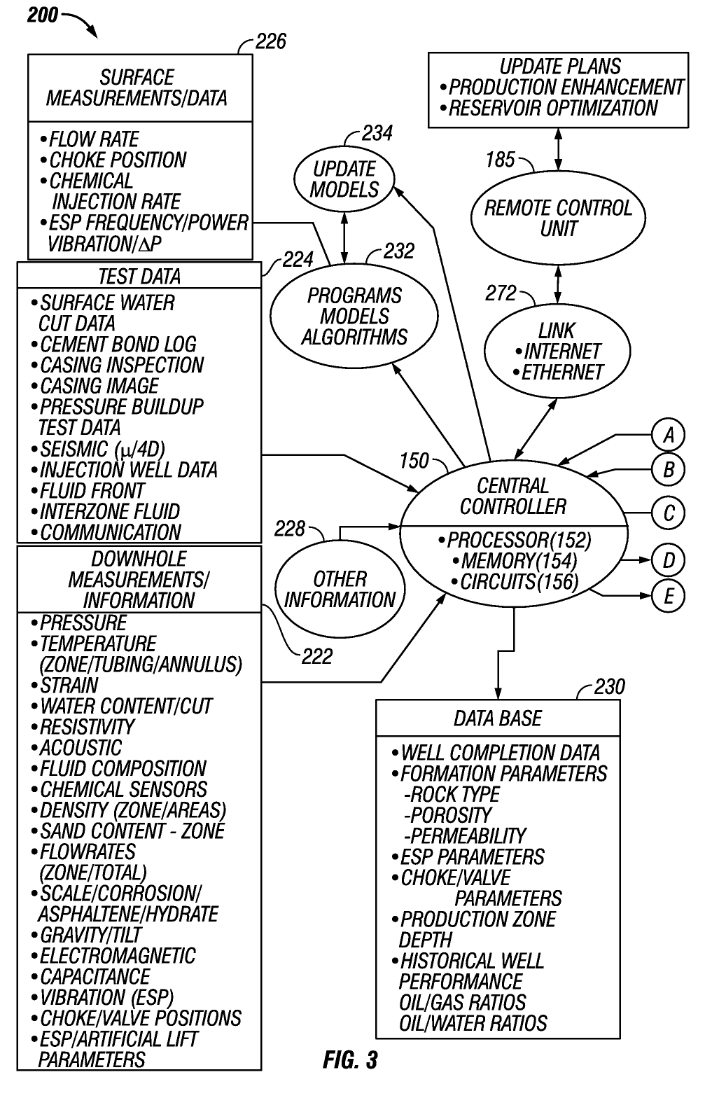

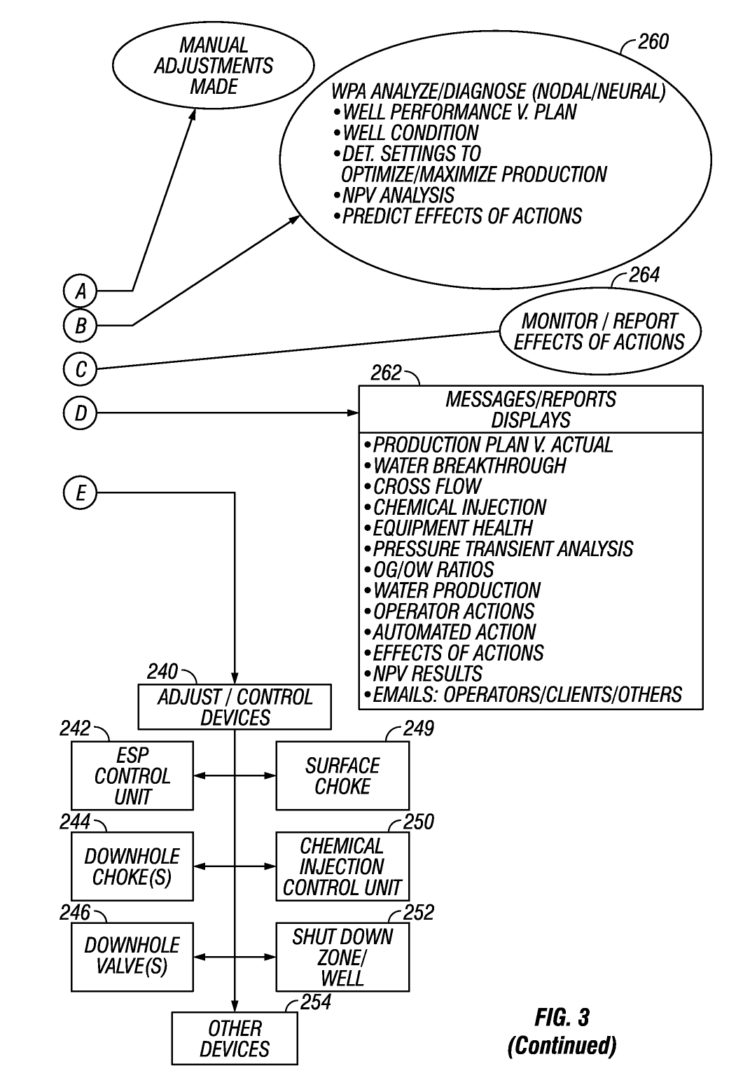

FIG. 3 shows a functional diagram of an exemplary production well system 200 that may be utilized to monitor, enhance, optimize, or maximize production from a well and for reservoir optimization. System 200 includes a central control unit or controller 150 that includes one or more processors, such as a processor 152, suitable memory devices 154 and associated circuitry 156 configured to perform various functions and methods described herein. The system 200 includes a database 230 stored in a suitable computer-readable medium that is accessible to the processors 152. The database 230 may include: (i) well completion data and information, such as types and locations of sensors in the well, sensor parameters, types of devices and their parameters, such as choke type and sizes, choke positions, valve type and sizes, valve positions, casing wall thickness, etc.; (ii) formation parameters, such as rock type for various formation layers, porosity, permeability, mobility, resistivity, and depth of each formation layer and production zone; (iii) sand screen parameters; (iv) tracer information; (v) ESP parameters, such as horsepower, frequency range, and operating pressure and temperature ranges; (vi) historical well performance data, including production rates over time for each production zone, pressure and temperature values over time for each production zone; (vii) current and prior choke and valve settings; (viii) intervention and remedial work information; (ix) sand and water content corresponding each production zone over time; (x) initial seismic data (two or three dimensional maps) and updated seismic data (four-dimensional seismic maps); (xi) water front monitoring data; (xii) and any other data that may be useful for monitoring and enhancing production from the well 50.

During the life of a well, one or more tests, collectively designated by numeral 224, are typically performed to estimate the health of various well elements and various parameters of the production zones and the formation layers surrounding the well. Such tests may include, but are not limited to: casing inspection tests using electrical or acoustic logs; well shut-in tests that may include pressure build-up or pressure transients, temperature and flow tests; seismic tests that may use a source at the surface and seismic sensors in the well to determine water front and bed boundary conditions; microseismic test data such as that may result from fracturing or water injection operations; fluid front monitoring tests; secondary recovery tests, etc. All such test data 224 may be stored in a memory and provided to the processor 152 for monitoring the production from well 50, performing analysis relating to enhancing, optimizing or maximizing production from the well 50, and for reservoir optimization.

Additionally, the processor 152 of system 200 may have periodic or continuous access to the downhole sensor measurement data 222 and surface measurement data 226 and any other desired information or measurements 228. The downhole sensor measurement data 222 includes, but is not limited to, information relating to water content or water cut, resistivity, density, viscosity, sand content, flow rates, pressure, temperature, chemical characteristics or compositions of fluids, gravity, inclination, electrical and electromagnetic measurements, oil/gas and oil/water ratios of fluids, and choke and valve positions. The surface measurements 226 include, but are not limited to, flow rates, pressure, choke and valve positions, ESP parameters, water content calculations, chemical injection rates and locations, tracer detection information, etc.

The system 200 also includes programs, models and algorithms 232 embedded in one or more computer-readable media that are accessible to the processor 152 to execute instructions contained in the programs. The processor 152 may utilize one or more programs, models and algorithms to perform the various functions and methods described herein. In one aspect, the programs/models/algorithms 232 may be in the form of a well performance analyzer (WPA) that is used by the processor 152 to analyze some or all of the measurement data 222, 226, test data 224, information in the database 230 and any other desired information made available to the processor to estimate or predict one or more parameters of the well operation.

In one aspect, the processor may be configured to determine the fluid flow rate from each zone, such as zones 52A and 52B of FIG. 2A and the combined flow rate, compare such flow rates to the expected flow rates and take actions when the actual flow rates fall below the expected levels, as shown in block 260. As noted earlier, in the initial phases of the reservoir optimization loop 1B, FIG. 1, an expected production plan is developed for the well. FIG. 5 shows a graph 500 corresponding to a hypothetical expected declining production curve 510 for the well 50. The declining curve 510 corresponds to the expected oil flow shown along the vertical axis and production time (in years) shown along the horizontal axis. Curve 550 represents the actual production from the well 50. At time zero the well is put into production and starts producing at the level 552 and continues to produce above the expected level until the production drops below the expected level at time 556.

The WPA analyzes data using one or more of sensor measurements, information from the database and test data and the current settings of the various flow devices and determines actions, which when executed are expected to enhance well production to or above the expected levels. The WPA utilizes the models, programs and algorithms to determine the actions that may be taken to enhance the production from the well. The WPA may also use nodal analysis to make such a determination and may calculate the enhanced levels of production once the determined actions have been taken. The processor sends the suggested actions as messages 262 to the operator and to the remote controller 185. The processor may also periodically or substantially continuously send certain information to the display 262 for use by the operator and/or remote controller 185, which information may include, but is not limited to, the production from each zone, current valve and choke settings, ESP frequency and throughput, information about the chemical build-up downhole, water cut corresponding to each zone, etc. The suggested actions may include altering ESP frequency, altering injection of chemicals, changing choke and valve settings, etc. WPA also may calculate the anticipated effect on the production of one or more of the suggested changes and the effect of the combined changes. In some situations, it may be desirable to reduce production from one zone and increase production from the other zone. In one aspect, the processor waits for the operator to make the suggested changes. If the operator does not take the actions, the processor may send reminders and may send messages to remote locations, including sending email messages. Once the operator takes the suggested actions, the production is shown to start to increase until time 558 and then starts to decrease until time 560. In one aspect, WPA may be configured not to wait till the production falls below the expected level as described with respect to time 556 but may extrapolate from the declining curve or slope and send a message to the operator to take one or more actions determined by the processor so that the operator may react early in time to maintain the production at a higher level. Eventually, the production from the well may decline below the expected level and in the example shown here additional actions taken at time 562 do not increase the oil production above the expected level and it may be desirable to perform a secondary recovery operation. The processor 152 may display the graphs shown in FIG. 5 on display for the operator. The analysis performed may be provided to the remote controller 185, which may use such information to update the reservoir characterization model (loop 1B, FIG. 1). The example shown in FIG. 5 corresponds to a scenario in which the actual production is grater than the expected production based on the initial model. In other situations, the actual production may start at a lower rate and may or may not exceed the expected production rate. The method described above still may be followed.

In another aspect, WPA analysis may show that to enhance or optimize production from the well, such as well 50, it is more desirable to produce from one well until the water cut exceeds a selected value. In other words, it may be desirable to produce from one zone until the water cut sensor reads greater that the economic limit for the well and its facilities. This system 200 then closes the first zone and opens the second zone and produces fluid in the manner described above as long it is considered economical.

In another aspect, the system 200 may predict the behavior of the fluid production from the well and adjust the well parameters so as to optimize or maximize production from the well. For example, WPA may predict a water breakthrough, or cross flow occurrence, or deterioration of a device or casing, etc., determine actions to be taken and provide messages to the operator as described above for altering the well parameters or may automatically execute such actions.

For example, WPA may estimate: the source or sources of the water breakthrough, such as the location at a production zone; location at the formations above and/or below a production zone; cracks in cement bond between the casing and the formation; location of a water front relative to the well, etc. WPA may also estimate the extent or severity of the expected water breakthrough and an expected time or time period in which the water breakthrough may occur. For estimating water breakthrough, the central controller 150 may estimate a measure of water (such as water content, water cut, etc.) relating to the formation fluid (for each zone and/or of the combined flow) over a time period and estimate or predict an occurrence of the water breakthrough using such water measure estimates. The controller 150 may utilize a trend associated with the water measures over a time period or utilize real-time or near real-time estimates of the water measures to detect and/or predict the occurrence of the water breakthrough. The measure of water in the formation fluid may be provided by an analyzer at the surface that determines the water content or water cut in the produced fluid 224. A water measure may include, but is not limited to, a quantity, a percentage of water cut, a threshold value, a magnitude of change in values, etc. The water measure or water content in the formation fluid may also be estimated from: the downhole sensors (such as resistivity or density sensors); analysis of tracers present in the produced fluid downhole or at the surface; density measurements; or from any other suitable sensor measurements. In another aspect, the processor may predict an occurrence of a water breakthrough using acoustic measurements from permanent sensors downhole or using microseismic measurements or four-dimensional seismic maps that provide an indication of the water front relating to a particular producing zone or from formation fractures associated with the producing zone. The processor also may predict the location and extent of the water breakthrough from estimating the deterioration of the casing from the casing inspection data or the deterioration in the cement bonds. In one aspect, the central controller utilizes forward-looking models or neural networks to determine the desired actions. These models may, for instance, assess the expected effectiveness of one or more actions, the costs associated with implementing one or more actions, perform a comparative analysis of two or more of such actions, etc.

Once the central controller 150 predicts a potential water breakthrough, it determines the actions to be taken to mitigate or eliminate the negative effects of the water breakthrough and still to optimize the production as long as feasible. The central controller 150 may recommend closing a particular production zone by closing a valve or choke; closing all zones; closing a choke at the surface; reducing fluid production from a particular zone; increasing production from an unaffected zone, altering frequency of the ESP or shutting down the ESP; altering chemical injection to a zone, etc. The central controller 150 sends these recommendations to an operator. If water breakthrough is associated with one zone to the exclusion of other zones, the system may recommend producing fluid from the potentially affected zone up to a particular time and then closing in such a zone prior to the occurrence of the water breakthrough. Alternatively, the system may recommend reducing the production from one zone and continue to production from other zones or in some cases the system may recommend increasing the production from one or more of the other zones. In each case, WPA, in one aspect, may determine a combination of actions that are likely to result in maximizing the production from the well until well is shut down for remedial actions.

As described above, the processor sends messages to the operator to take the desired actions, sends such information to the remote controller and displays the desired data for use by the operator. The processor continues to monitor the effects of the actions taken by the operator in a manner similar to as described above in reference to FIG. 5. Once the operator makes a change in, the central controller 150 continues to computes the water breakthrough information and continues to operate in the manner described above. In another aspect, when the central controller 150 determines an impending water breakthrough or an alarm condition, it may initiate one or more desired actions.

In another aspect, hydrocarbon production may be enhanced by reducing the production of water from the production zones based on a selected criterion. WPA may determine the production rates from different zones that will reduce the water produced from the well but will maintain or enhance the production of the hydrocarbons from the well. In one aspect, WPA determines such production levels that will also maintain the pressure at a desired value or within a selected range. The WPA then determines the settings for the valves and chokes, the frequency of or power to the ESP, and the chemical injection rates. The processor sends the messages to the operator and the remote controller and performs the other functions in a manner similar to the manner described above.

In another aspect, the system 200 may act to change production when it determines or predicts a cross-flow condition. Under normal operating conditions of the well 50, pressure corresponding to the lower production zone 52b will be greater than the pressure corresponding to the upper production zone 52a. Under such a condition, the formation fluid 56a from the upper production zone will flow toward the surface as shown by arrows 77A. However, under certain conditions, the formation pressure “Pu” corresponding to the upper production zone 52a may start to increase and eventually become greater than the pressure “Pl” of the lower production zone 52b. As this pressure shift occurs, the formation fluid from the upper production zone starts to flow toward the lower production zone. At some point in time the pressure Pu and Pl cross over. Under such a scenario, the wellbore 50 may not be able to support production of the formation fluids 56a and 56b and may cause damage to one or more devices in the wellbore, such as the ESP 30 and may cause damage to the wellbore in general. In one aspect, the central controller 150 continually estimates the pressures Pu and Pl and utilizes a model or program to predict the occurrence of the cross-over condition and determines one or more actions to be taken in response to cross flow detection. The WPA may contain one or more models and/or algorithms, which may be based on historical or laboratory or other synthetic data to determine the expected time of the occurrence of the cross over. The models may take into account any number of factors, such as the percent pressure in the wellbore is above the formation pressure and the length of time such a condition has been present; rate of change of the pressures Pu and Pl; the difference between the pressures Pu and Pl, the temperatures corresponding to the upper and lower production zones; whether the annulus (upper zone) has higher pressure than the tubing (lower zone) and that the lower zone is open for producing fluids; and when flow measurements downhole indicate that the flow is approaching a cross flow condition; and any other desired factors. The central controller also estimates the severity and timing of the potential cross-flow condition and determines the actions to be taken. The central controller may send warning signals or alarms along with one or more recommended actions, including but not limited to recommendations to: close or partially close a particular choke; e.g., choke 40; to prevent or inhibit the flow of the formation fluid 56a into the tubing 45; close sliding sleeve valve 67; change the speed (frequency) of the ESP 30 or shut down ESP 30; change the amount of the additives 113a or 113b being injected into the wellbore 50 and the surface processing unit 170; close or isolate a particular zone; decrease surface pressure; open surface choke; reduce the flow through or close a particular choke; and any other suitable recommendation. In one aspect, the recommended actions may correspond to optimizing production from the well. The central controller 150 continues to monitor the wellbore parameters described herein to continually assess the impact of the changes made by the operator and continues to provide additional inputs and recommendations in a manner similar as described herein.

In another aspect, the system 200 may recommend or take actions based on the health of the equipment. For example, system 200 may determine corrosion or scale build-up on a device, such as a valve or that the ESP is operating outside specified parameters or deterioration in the casing or the cement bond, etc., and in response thereto determine an action plan that may provide optimal net present value for the well. The system 200 then seeks to implement the plan substantially in the manner described above.

In another aspect, WPA may analyze data to reduce or minimize sand production from each production zone. In one aspect the processor 152 may monitor a measure of the sand produced from each zone and using a nodal analysis predict the production of sand from each zone. The processor may monitor the pressure corresponding to each production zone and estimate therefrom and/or by using other data the sand production or expected sand production from each production zone. The processor then determines the actions to be taken which will result in decreased sand production and/or enhanced production of hydrocarbons. The actions may include decreasing the production from the affected zone, increasing production from another zone, shutting down production from the affected zone or any combination thereof. WPA then sends messages to the operator via display containing the actions. The actions also may include altering the speed of the ESP and changing chemical injection to account for the change in production from different zones. The system 200 continues to monitor the effects of the changes made by the operator and may also be configured to go into an automatic mode to initiate any action automatically.

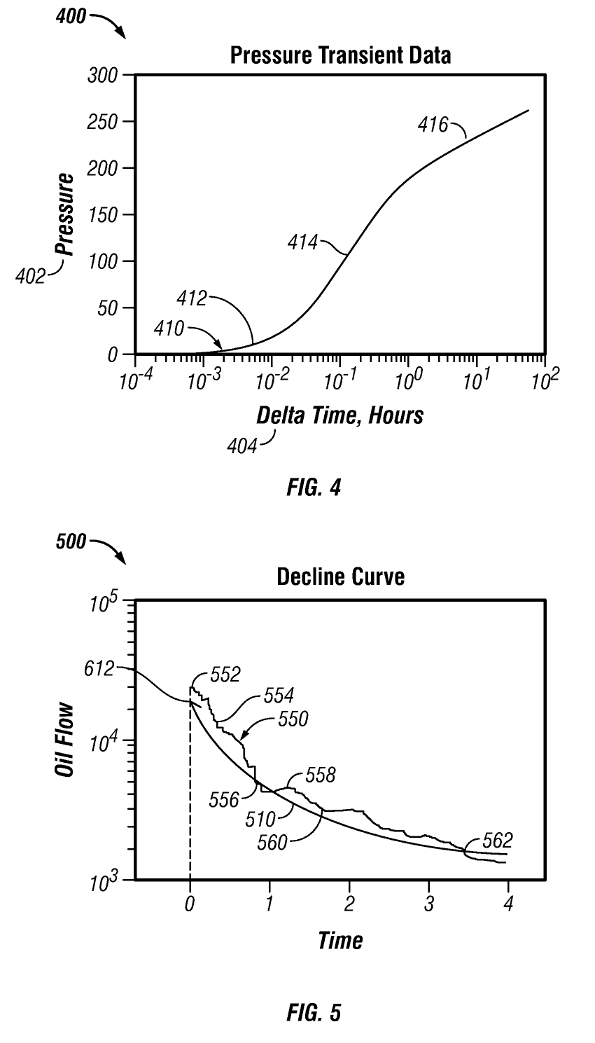

In another aspect, WPA may be configured to analyze transient pressure condition data and estimate the production from each zone and adjust the equipment parameters to enhance, optimize or maximize the production from the well. FIG. 4 shows a graph 400 of an example of a pressure transient curve over time, wherein the pressure is shown along the vertical axis and time is shown along the horizontal axis. The pressure curve shown is for the time after the production zone is shut in. The pressure prior to the shut is typically substantially constant. As the production zone is shut in, the pressure tends to increase slowly for a short period of time, such as the period ending at time 412 and then increases at a substantially constant rate as shown by section 414 and then tapers off as shown by section 416. WPA analyzes the pressure transient data and determines the settings for the various devices in the well system 10 to enhance the production from the well based upon selected criteria and sends the new settings to the operator or automatically sets the devices to their new setting and then continues to monitor the effects of the new settings and provide feedback similar to the manner described above.

In another aspect, WPA may analyze the well test data and determine new production parameters and determine corresponding new settings. In another aspect, WPA may estimate the presence and/or build-up rates of chemicals, such as scale, corrosion, hydrates and asphaltenes and may estimate their the effects on the production rates and the health of certain devices, such as valves, chokes, ESP and tubings. WPA determines the actions and sends corresponding messages to the operator and the remote locations and performs the follow-up functions in the manner described above. The actions may include altering chemical injection rates, altering ESP speed, altering flow from one or more zones, moving components of valves and chokes to clean up corrosion or scale, etc.

In certain situations, various parameters and settings may be interdependent. For example, reducing production from one zone, by setting a choke to a lower flow position, may change the pressure in the well and flow rate from another zone and also may call for a different setting of the ESP and different chemical injection rates, etc. As another example, shutting production from one zone may provide the desired enhanced hydrocarbon production but may be detrimental to the ESP because the ESP may operate out of specifications if its speed is reduced to a frequency that matches the production rate. In such a case, it may be desirable to operate the ESP at a higher production rate and produce small proportion of the fluid from the zone that was originally selected to be shut down. In any of the above described scenarios, WPA, in one aspect, determines the actions or settings based on meeting a selected criterion or criteria so as to enhance, optimize or maximize production from the well. WPA may perform a nodal analysis or use forward looking models that provide settings of the various devices.

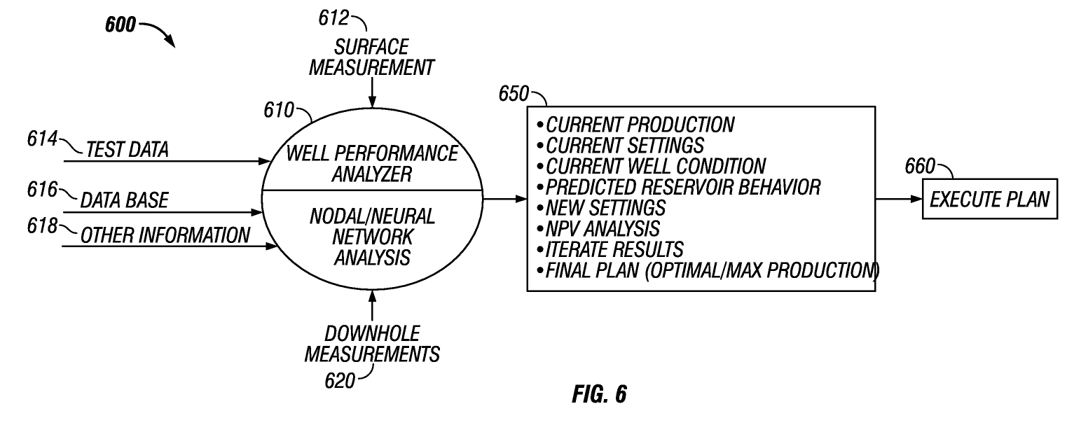

FIG. 6 shows a functional block diagram 600, wherein WPA 610 performs a nodal analysis, uses neural networks and/or other forward looking models to determine the various operating parameters, such as the settings for the various devices, to obtain enhanced production from a particular well configuration. In one aspect, WPA 610 receives surface measurements or results computed from the surface measurements 612, downhole measurements or results computed from the downhole measurements, 620, test data 614, information from the database 616 and any other information 618 that may be pertinent to a particular well and the uses a nodal analysis and/or another forward looking models to obtain new settings. The nodal analysis may include prediction the effects of the new settings on the production and iterate this process until a combination of new settings (final plan) is determined that will enhance, optimize or maximize the production form the particular well. In one aspect, such a determination may or may not account for the effect of the plan on the production from the field. In another aspect, the nodal analysis may be based in part on a net present value analysis so that the new settings are expected to provide a higher overall net present monetary amount from the production from the well, such as shown in box 650. WPA attempts to implement the actions in the manner described above.

Referring back to FIG. 2B, the central controller may be configured to automatically initiate one or more of the recommended actions, for example, by sending command signals to the selected device controllers, such as to ESP controller to adjust the operation of the ESP 242; control units or actuators (160, FIG. 1A and element 240) that control downhole chokes 244, downhole valves 246; surface chokes 249, chemical injection control unit 250; other devices 254, etc. Such actions may be taken in real time or near real time. The central controller 150 continues to monitor the effects of the actions taken 264. In another aspect, the central controller 150 or the remote controller 185 may be configured to update one or more models/algorithms/programs 234 for further use in the monitoring of the well. Thus, the system 200 may operate in a closed-loop form to monitor the performance of the well, take or cause to take desired actions, and continue to monitor the effects of such actions.

While the foregoing disclosure is directed to the certain exemplary embodiments and methods, various modifications will be apparent to those skilled in the art. It is intended that all such modifications within the scope of the appended claims be embraced by the foregoing disclosure. Also, the abstract is provided to meet certain statutory requirements and is not to be used to limit the scope of the claims.

What is claimed is:

1. A method of producing fluid from a well, comprising:
estimating an expected fluid flow rate from at least one production zone of the well as a function of time for a first setting of at least one flow control device in the well;
monitoring actual flow rate of the fluid from the at least one production zone into the well corresponding to the first setting of the at least one flow control device; and
determining, using a computer model and a plurality of inputs selected from downhole sensor measurements, surface sensor measurements and parameters of the at least one flow device, a second setting of the at least one flow control device from a declining trend of the actual flow rate, which second setting will increase the flow rate of the fluid from the well to at least the expected fluid flow rate; and
configuring the well corresponding to the at least one second setting to obtain enhanced production of the fluid from the well.

2. The method of claim 1 further comprising determining a second expected fluid flow rate over time for the well based on the at least one second setting.

3. The method of claim 2 further comprising computing a net present value (NPV) for the well based on the second expected fluid flow rate.

4. The method of claim 1, wherein the plurality of inputs are selected from a group consisting of information relating to: pressure in the well; flow rates in the well; flow rates at the surface; operating parameters of an electrical submersible pump; chemical injection rate; temperature; resistivity; density of the fluid; fluid composition; capacitance measurement; vibration; acoustic measurements; differential pressure across a device; water content; oil-water ratio; gas-and oil ration; oil-water ratio.

5. The method of claim 4 wherein the group further consists at least one of: micro-seismic measurements; pressure transient test measurements; well log measurements; measurements relating to presence of a chemical in the well that is one of scale, hydrate, corrosion and asphaltene, paraffin.

6. The method of claim 1 further comprising:
estimating an occurrence of at least one of a: water breakthrough; cross-flow condition; deterioration of a casing in the well; deterioration of a device in the well; and determining the at least one second setting based on such estimation.

7. The method of claim 1 further comprising, altering at least one of: a chemical injection rate; operation of an ESP; shutting in a selected production zone when the well includes a plurality of production zones.

8. The method of claim 1 further comprising sending a message relating to the at least one second setting to at least one of: an operator; and a remote location from the well.

9. The method of claim 1, wherein the at least one second setting includes a change in position of the at least one device, a change in a chemical injection rate and a change in fluid flow rate from an artificial lift mechanism in the well.

10. The method of claim 1 further comprising updating the expected fluid flow rate based on the at least one second setting.

11. The method of claim 1 further comprising monitoring the actual flow rate of the fluid from the at least one production zone into the well over a time period corresponding to the at least one second setting; and determining a third setting from a declining trend of the actual flow rate after operating the well at the at least second setting a third setting that will enhance the fluid flow from the at least one production zone.

12. A system for obtaining enhanced production from a well that includes a plurality of production zones, a separate flow control device associated with each production zone and an artificial lift device, the system comprising:
a computer system that includes a processor, a computer readable medium for storing computer programs and database that is accessible to the computer for executing instructions contained in the computer program and a display device for displaying information sent by the processor, wherein the computer program comprises;
a set of instruction to monitor actual flow rate of the fluid from each production zone over a time period corresponding to a first setting of each flow control device and the flow through the artificial device;
a set of instructions to utilize a nodal analysis on a plurality of inputs selected from downhole sensor measurements, surface sensor measurements, current position of at least one flow control device to determine a new setting for at least one flow control device from a declining trend of the actual flow rate to obtain enhanced production rate from the well; and
a set of instructions to continue to monitor the enhanced flow rate corresponding to the new setting.

13. The system of claim 12, wherein the computer program further comprises instructions to compute an expected enhanced fluid flow rate for the well based on the new setting.

14. The system of claim 13, wherein the computer program further includes instructions to compute a net present value (NPV) for the well based on the computed enhanced fluid flow rate.

15. The method of claim 12, wherein the plurality of inputs are selected from a group consisting of information relating to: pressure in the well; flow rate in the well; flow rate at the surface; an operating parameter of an electrical submersible pump; a chemical injection rate; temperature; resistivity; density of the fluid; fluid composition; a capacitance measurement relating to the fluid; vibration; acoustic measurements in the well; differential pressure across a device in the well; water content; oil-water ratio; gas-oil ratio; and oil-water ratio.

16. The method of claim 15 wherein the group further consists information relating to: micro-seismic measurements; pressure transient measurements; well log measurements; a measurement relating to presence of a chemical in the well that is one of scale, hydrate, corrosion, paraffin, and asphaltene.

17. The system of claim 12, wherein the computer program further comprises a set of instructions to: estimate an occurrence: cross flow condition; deterioration of a casing in the well; and deterioration of a device in the well; and
determine the new setting based on at least one such estimation.

18. The system of claim 12, wherein the computer program further comprises a set of instructions that uses a selected criterion to determine the new setting.

19. The system of claim 18, wherein the selected criterion includes at least one of: sand production is less than a selected amount; water content from a selected production zone is below a selected amount; a cross flow-condition is not present; deterioration of a device in the well is within selected limits; and ESP operation is within selected limits.

20. The system of claim 12, wherein the at least one new setting includes aplurality of: a change in position of the at least one device, a change in a chemical injection rate and a change in fluid flow rate from an artificial lift mechanism in the well.
